(19) United States
(12) Patent Application Publication
(10) Pub. No.: US 2024/0275103 A1
(43) Pub. Date: Aug. 15, 2024

(54) ENHANCED POWER OUTLET

(71) Applicants: Stephen Yacktman, Austin, TX (US); Russell Aldridge, Round Rock, TX (US); Marc Christenson, Round Rock, TX (US)

(72) Inventors: Stephen Yacktman, Austin, TX (US); Russell Aldridge, Round Rock, TX (US); Marc Christenson, Round Rock, TX (US)

(21) Appl. No.: 18/438,448

(22) Filed: Feb. 10, 2024

Related U.S. Application Data
(60) Provisional application No. 63/444,889, filed on Feb. 10, 2023.

(51) Int. Cl. H01R 13/512; H01R 13/447; H01R 13/635

(52) U.S. Cl. CPC H01R 13/512; H01R 13/447; H01R 13/635

(57) ABSTRACT

This disclosure describes systems, methods, and devices related to an enhanced power outlet. A system may provide an outlet housing insert designed to fit within a standard outlet box. The system may integrate a spring mechanism, including a plastic spring cover over a springing mechanism. The system may configure the spring mechanism to enable removal of a standard electrical outlet from the outlet housing insert. The system may include multiple metal female contacts within the outlet housing insert, designed to receive a modified standard outlet and form a connection with the outlet's male contacts.

### CROSS-REFERENCE TO RELATED APPLICATION(S)

This application claims the benefit of U.S. Provisional Application No. 63/444,889, filed Feb. 10, 2023, the disclosure of which is incorporated by reference as set forth in full.

### TECHNICAL FIELD

This disclosure generally relates to power outlets and more particularly, to an enhanced power outlet associated with an electrical box.

### BACKGROUND

Traditional power outlets present several challenges due to their fixed nature and the requirement for professional installation, often leading to high costs and inconvenience for users who need to modify or upgrade their electrical setups. These outlets lack flexibility for easy adaptation to different plug types or emerging technologies, and the process of changing them can be time-consuming and requires electrical expertise. Furthermore, the inherent risks associated with electrical work, such as the potential for accidents or improper installations, add to the complications. These factors culminate in a clear need for an innovative approach to electrical outlet design that addresses these limitations.

### BRIEF DESCRIPTION OF THE DRAWINGS

FIGS. 1A-1C depict illustrative schematic diagrams for an enhanced power outlet, in accordance with one or more example embodiments of the present disclosure.

FIGS. 2, 3, 4A-4C, and 5A-5B depict illustrative schematic diagrams for an enhanced power outlet, in accordance with one or more example embodiments of the present disclosure.

FIG. 6 depicts an illustrative schematic diagram for an enhanced power outlet, in accordance with one or more example embodiments of the present disclosure.

FIG. 7 depicts an illustrative schematic diagram for an enhanced power outlet, in accordance with one or more example embodiments of the present disclosure.

FIG. 8 depicts an illustrative schematic diagram for an enhanced power outlet, in accordance with one or more example embodiments of the present disclosure.

FIG. 9 depicts an illustrative schematic diagram for an enhanced power outlet, in accordance with one or more example embodiments of the present disclosure.

FIG. 10 depicts an illustrative schematic diagram for an enhanced power outlet, in accordance with one or more example embodiments of the present disclosure.

FIG. 11 illustrates a flow diagram of a process for an illustrative enhanced power outlet system, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Occupational safety and health administration (OSHA) defines a ground fault circuit interrupter (GFCI) as “A device intended for the protection of personnel that functions to de-energize a circuit or portion of a circuit within an established period of time when a current to ground exceeds some predetermined value that is less than that required to operate the overcurrent device (circuit breaker or fuse) of the supply circuit.”

GFCI outlets are required to be installed by code anywhere where water is close by, such as in a residential home next to a sink, in the bathroom, or outside. Since GFCI outlets, especially those mounted outside, are subject to environmental conditions such as water, heat, and cold and since they have additional electronics incorporated internally to provide the projection they do, they fail more often than standard outlets and need to be replaced.

In several embodiments, the proposed enhanced power outlet system aims to improve the functionality of conventional off-the-shelf Ground Fault Circuit Interrupter (GFCI) plugs, as well as specially designed plugs. It's important to note that while GFCI outlets are specifically mentioned in this disclosure, the scope of the enhancement is not limited to them. Various other types of power outlets could also integrate the advancements detailed in these embodiments, thereby extending the potential applications and benefits of the disclosed system beyond just GFCI outlets.

In various embodiments of the enhanced power outlet system, a key innovation is the integration of a spring mechanism in the base. This feature is not only beneficial for GFCI outlets but is also adaptable to various other types of outlets. The spring performs two critical functions: it assists in the easy removal of the outlet, and it ensures that the outlet, whether GFCI or another type, is securely held against the side tabs that are instrumental in locking the plug into the assembly. This versatile design of the spring mechanism in the enhanced power outlet system significantly enhances user convenience and connection stability across a range of outlet types.

In various embodiments of the enhanced power outlet system, a distinctive feature is the use of a ground electrical contact that is longer than the live (neutral or load) contacts. This design ensures that a ground connection is established first when a plug is inserted into the socket. This approach, which can be applied to a range of outlet types beyond just GFCI, results in a safer design. By prioritizing the ground connection, the system minimizes the risk of electrical shock or short-circuiting, enhancing safety for users across multiple outlet formats.

Existing products do not appear to be a finger safe design when replacing their switches. That is, the power breaker should be turned off before replacing the switch.

Existing product designs are not as compact as the enhanced power outlet system in many ways, and thus require uniquely designed smaller light switches to fit inside their backplate product, as opposed to standard off-the-shelf items like a GFCI outlet (GFCIs are one of the largest devices installed in electrical boxes).

Example embodiments of the present disclosure relate to systems, methods, and devices for quickly changing out power outlets from a standard electrical box.

In one or more embodiments, the enhanced power outlet system is designed to revolutionize the way electrical outlets are installed and maintained. This system notably simplifies the replacement of electrical plugs, such as GFCI outlets, allowing for a quick and tool-less process. Users can effortlessly remove the snap-on cover and pull spring tabs away from the plug, enabling it to pop out of the enclosure without the need for professional assistance. This feature significantly enhances the convenience and accessibility of maintaining electrical outlets.

In another embodiment, the enhanced power outlet system demonstrates its versatility in handling different electrical requirements. It is capable of being used with various voltages, including but not limited to 120VAC, 240VAC, and 208VAC 3-phase power. This flexibility makes the system suitable for a wide array of applications, from residential to commercial settings, accommodating different electrical infrastructures.

In certain embodiments of the enhanced power outlet system, a significant feature is its capability for voltage conversion. This functionality allows the system to adapt to different electrical environments by modifying the voltage level as required. The system can down-convert from higher to lower voltages, which is particularly useful in settings where devices or appliances require a lower voltage than what is available from the main power supply. For example, in a scenario where the main supply provides 240VAC, but certain equipment operates optimally at 120VAC, the enhanced power outlet system can effectively reduce the voltage to match the equipment's requirements. This down-conversion process ensures that devices are not only safely powered but also function efficiently, avoiding any damage or performance issues that might arise from over-voltage. Conversely, the system is also capable of up-converting from lower to higher voltages. This feature is beneficial in situations where the available power supply provides a voltage level that is insufficient for certain appliances or equipment. For instance, if the main supply is at 120VAC and a particular device requires 240VAC, the enhanced power outlet system can increase the voltage to meet this need. This ability to up-convert ensures that the full range of electrical appliances and equipment can be used, even in environments where the main power supply does not initially meet their voltage requirements. This adaptability of the enhanced power outlet system is especially advantageous in diverse settings where variable voltage requirements are prevalent, such as in industrial, commercial, or multi-purpose buildings. Overall, the voltage conversion capability of the enhanced power outlet system highlights its versatility and adaptability, making it a highly suitable solution for a wide range of electrical environments. This functionality not only enhances the usability of the system but also contributes to the safety and efficiency of the electrical installations it supports.

Furthermore, the enhanced power outlet system may comprise an outlet housing insert, which is designed to fit within a standard outlet box. This insert is securely attached using top and bottom center screws, ensuring stability and safety. The system's design also includes side tabs and a spring mechanism, which facilitates the secure placement and effortless removal of the outlet, making maintenance and replacement tasks straightforward and safe. The enhanced power outlet system, with its various embodiments, stands out as a versatile, efficient, and user-friendly solution for diverse electrical installation needs.

The above descriptions are for the purpose of illustration and are not meant to be limiting. Numerous other examples, configurations, processes, etc., may exist, some of which are described in detail below. Example embodiments will now be described with reference to the accompanying figures.

The following Figures depict illustrative schematic diagrams for enhanced power outlet, in accordance with one or more example embodiments of the present disclosure.

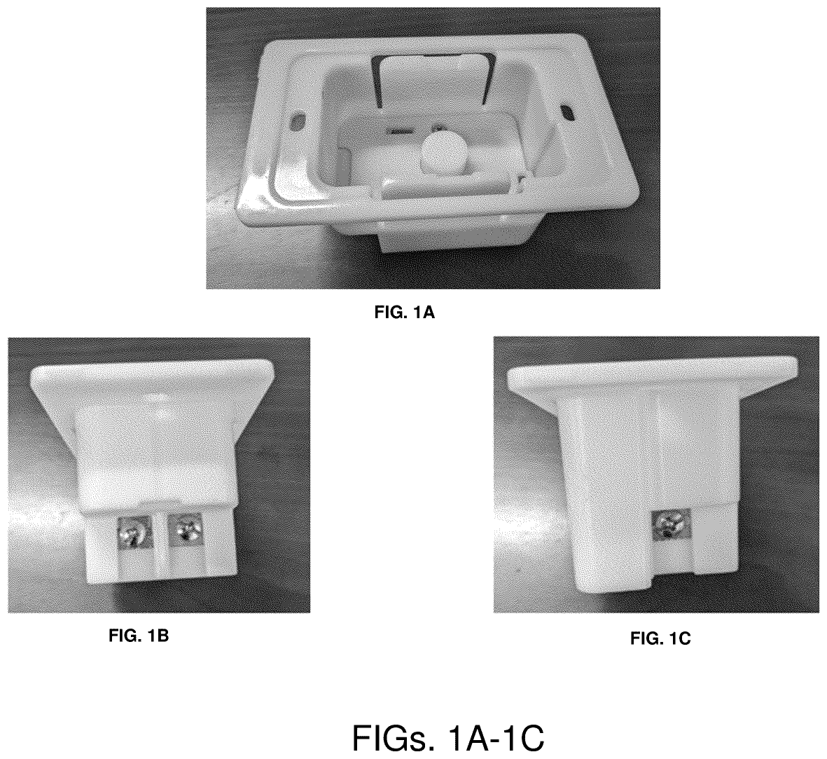

FIGS. 1A-1C depict illustrative schematic diagrams for an enhanced power outlet, in accordance with one or more example embodiments of the present disclosure.

Referring to FIGS. 1A-1C, an outlet housing insert is displayed, designed specifically for attachment to electrical wiring within a wall. To facilitate this attachment, the design incorporates a plurality of contact points. These contact points are crucial for creating a secure connection between the electrical wiring and the outlet housing insert. This design choice is pivotal in ensuring a stable and reliable electrical connection, which is essential for both safety and functionality.

In FIGS. 1B and 1C, the outlet housing insert is shown with three contact points that utilize screws to connect the electrical wiring to the insert. The use of screws is a practical approach, as it allows for a strong mechanical connection, ensuring the wires are firmly held in place. This feature is particularly beneficial for preventing loose connections, which can be a common issue in electrical installations. However, it's important to note that other mechanisms may also be used to connect the contact points to the electrical wiring. This flexibility in the attachment method allows for customization based on specific requirements or preferences, making the outlet housing insert adaptable to a variety of electrical setups. The ability to use different mechanisms for connection points also suggests that the design can be tailored to accommodate different wire types and sizes, enhancing the system's versatility, and making it a suitable option for diverse electrical infrastructure needs.

In one or more embodiments, an enhanced power outlet system may enable a homeowner to quickly and easily replace a GFCI outlet without tools and without turning off the power to the GFCI plug when the GFCI easy replaceable holder has been installed. This feature significantly simplifies the process, making it more accessible for homeowners with little to no electrical expertise.

In one or more embodiments, an enhanced power outlet system may enable a home builder to add a valuable selling point to a home by enabling new homeowners to easily replace or update their outlets without the need for an electrician. This addition could increase the market appeal and value of homes by offering a unique and practical feature.

In one or more embodiments, an enhanced power outlet system may be expanded to include other electrical plugs and light switches, including smart electrical devices with wireless or other communication capabilities. Although GFCI is given as an example, many electrical plugs or light switches may be suitable to be enhanced using the enhanced power outlet system. This versatility broadens the scope of the system, making it applicable to a wide range of electrical fixtures.

Homeowners typically address the issue of faulty electrical plugs in one of three ways. The first option involves hiring an electrician, which can cost hundreds of dollars to replace a simple plug. Alternatively, some choose to replace the outlet themselves, which not only poses a risk of electrical shock but also becomes a repetitive inconvenience each time the plug fails. The third and most innovative solution is to install the GFCI easy replaceable holder. This method makes GFCI plug replacements tool-less and straightforward, allowing the average homeowner to carry out the task without the risk of electrical shock. This approach is both safer and more cost-effective, presenting a significant improvement over the traditional methods.

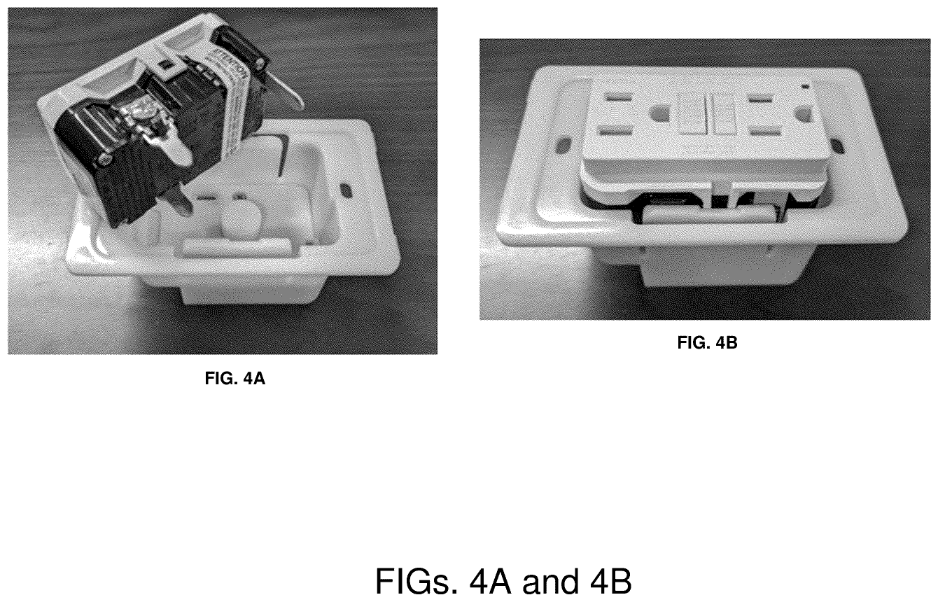

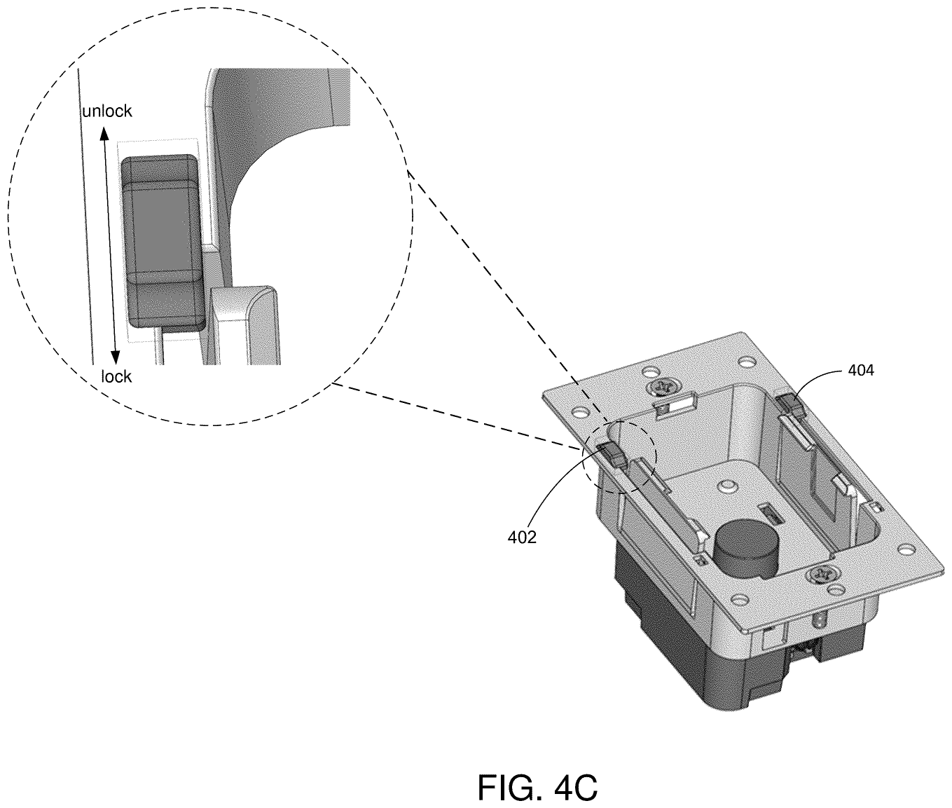

The enhanced power outlet system offers several advantages. Key features include snap tabs that securely grip and hold in the GFCI plug, making it more reliable and stable compared to traditional plugs. A spring mechanism assists in easily popping out the plug when it needs to be removed, which is especially useful for those who are not familiar with electrical systems. The addition of locking sliders (see, FIG. 4C) for the snap tabs further allows the GFCI plug to be secured against pulling out. These locking sliders are small plastic pieces that slide behind the snap tabs that hold the GFCI plug in place. Sliding these behind the tabs reinforces the connection and ensures that the GFCI cannot be pulled out, such as in the case of a plug pulled aggressively out of the GFCI outlet. The system is designed with a finger-safe feature, eliminating the need to turn off electricity to the outlet box during replacement, thereby reducing the risk of accidental electric shock.

The enhanced power outlet system is compatible with existing off-the-shelf commercial GFCI outlets that are UL certified, which means there's no need to design a custom GFCI plug or undergo the expensive GFCI UL certification process, streamlining the installation process and cutting down on unnecessary expenses. This ensures both compatibility and safety without additional costs. Additionally, the system includes blind stab electrical contact terminals that mount to an existing commercial GFCI outlet, further enhancing the ease of installation.

An important safety feature is that the ground stab electrical contact is longer than the neutral and load contacts. This thoughtful design ensures a safer installation process by prioritizing the ground connection, which is crucial for preventing electrical hazards. This design ensures that the ground connection is made first when inserting the plug into the socket, prioritizing safety by establishing a ground connection before other contacts are made. Moreover, this enhanced system is compatible with existing off-the-shelf snap-on wall covers, allowing for seamless integration into the aesthetics of any room without the need for additional adjustments or accessories.

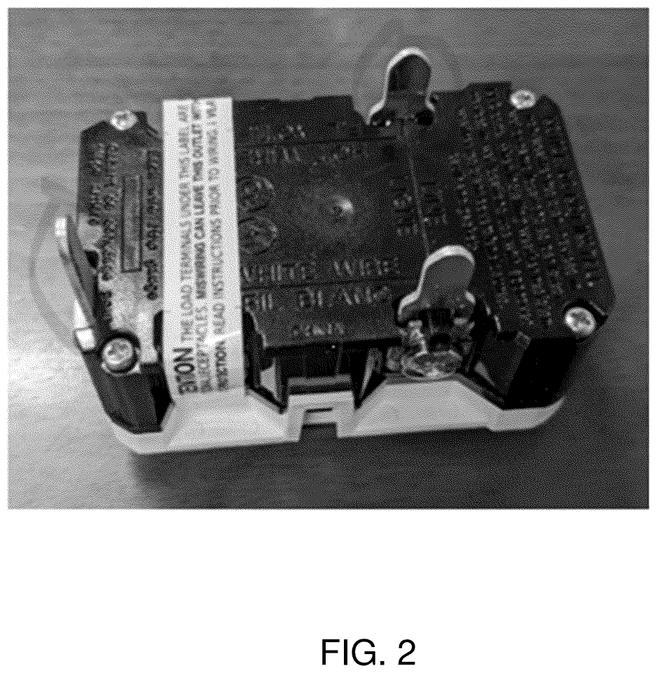

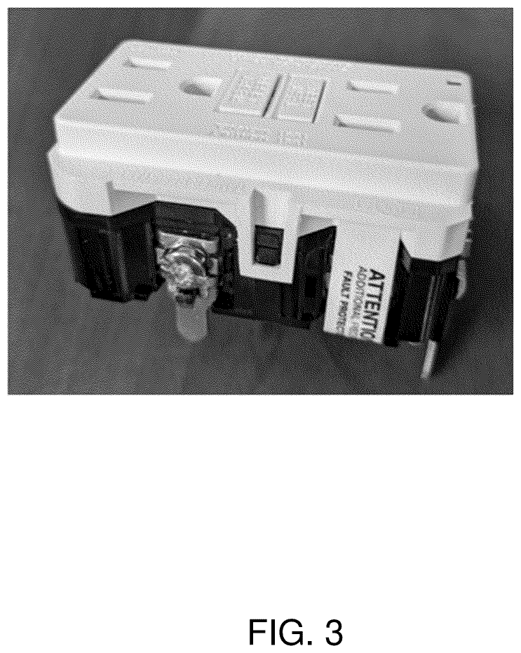

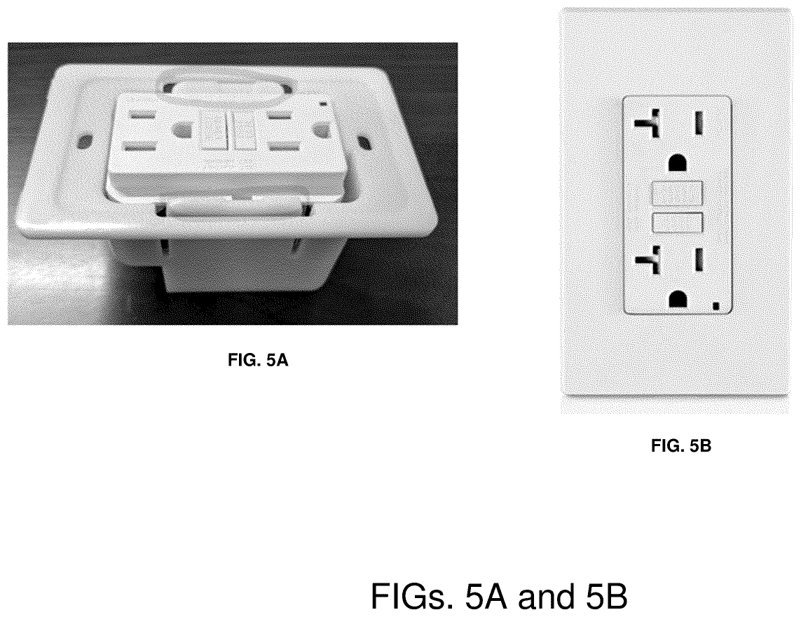

FIGS. 2, 3, 4A-4C, and 5A-5B depict illustrative schematic diagrams for an enhanced power outlet, in accordance with one or more example embodiments of the present disclosure.

Referring to FIGS. 2, 3, 4A-4C, and 5A-5B, installation steps and replacement steps are shown. The initial step in the installation process involves installing the GFCI easy replaceable holder into a standard outlet box using electrical contact terminals. This crucial step ensures a solid foundation for the enhanced system, providing a secure and stable base for the GFCI plug. This step should be done by an electrician or someone familiar with replacing electrical outlets, as their expertise provides a safe and proper installation, reducing the risk of electrical mishaps.

The second step in the initial installation process involves adding terminal extensions to the GFCI plug. Ideally, these terminal extensions come pre-installed on the GFCI plug, in a kit, facilitating a toolless assembly that can be conveniently performed by the homeowner, enhancing the user-friendly aspect of the system.

The third step in the installation process is to insert the plug into the GFCI easy replaceable holder. This involves pressing down on the plug until it securely snaps into place, indicating a successful and firm connection. This snapping mechanism is designed for a secure fit, ensuring that the plug remains stable and reliable in its position. After the plug is securely in place, the next step is to snap on the wall plate. This installation emphasizes the user-friendly nature of this system, making it accessible for individuals with varying levels of experience in electrical installations.

The replacement steps for the system are straightforward and designed for ease of use. The first step involves removing the snap-on wall plate, which can be done without any tools. Alternatively, the system can be used with standard screw on wall plates making more wall plate and accessory options available to users. This feature emphasizes the system's user-friendly design, allowing for quick access to the outlet without the need for specialized equipment. Next, the retaining tabs holding in the GFCI outlet need to be pulled out. These tabs are engineered for easy release, yet they securely hold the outlet in place during regular use.

In one or more embodiments, additional locking sliders (e.g., locking sliders 402 and 404) for the snap tabs further allows the GFCI plug to be secured against pulling out. These locking sliders are small plastic pieces that slide behind the snap tabs that hold the GFCI plug in place. Sliding these behind the tabs reinforces the connection and ensures that the GFCI cannot be pulled out, such as in the case of a plug pulled aggressively out of the GFCI outlet.

Upon releasing the tabs, the outlet will spring upwards, thanks to the spring built into the GFCI easy replaceable holder. This automatic spring action not only makes the removal process smoother but also reduces the effort required, making it more convenient for the user. The final step is to remove the GFCI plug, replace it, and re-assemble the components. The simplicity of this process underscores the innovative design of the system, making electrical maintenance tasks accessible and less daunting for homeowners.

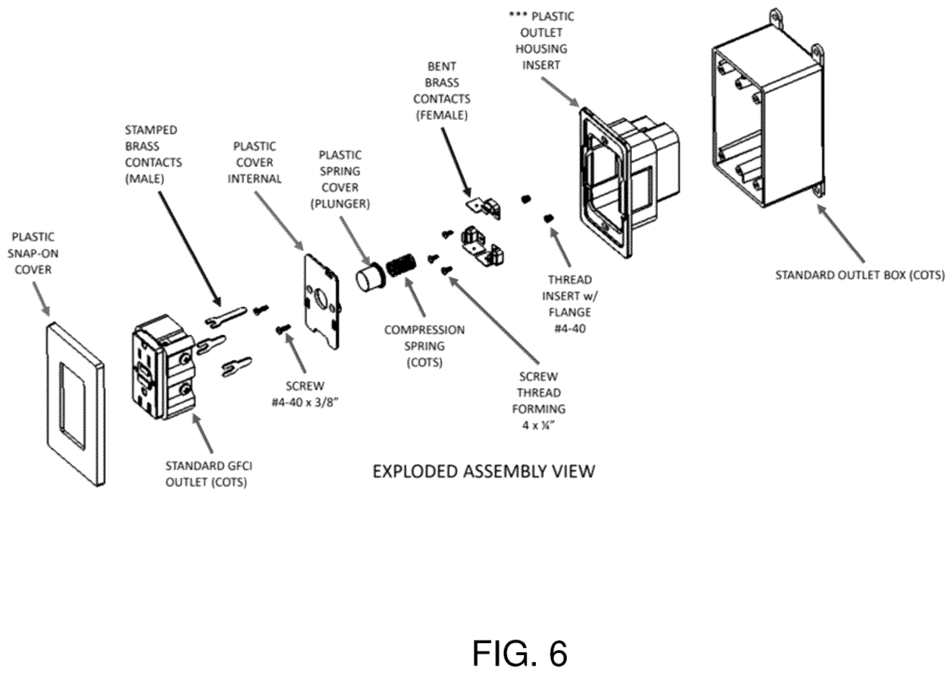

FIG. 6 depicts an illustrative schematic diagram for an enhanced power outlet, in accordance with one or more example embodiments of the present disclosure.

Referring to FIG. 6, there is shown an exploded assembly view of the enhanced power outlet system.

The enhanced power outlet system is designed to incorporate a standard outlet, such as a GFCI outlet, which is modified for use in this innovative installation. This standard outlet is equipped with stamped brass contacts, typically male, that are attached to the contacts of the standard outlet. These can be attached using existing mechanisms such as screws or other types of attachment mechanisms, enhancing the system's adaptability and ease of integration with existing electrical setups.

Furthermore, the enhanced power outlet system includes a unique internal structure consisting of a plastic cover placed between the standard outlet and a spring mechanism. This mechanism may comprise a plastic spring cover, such as a plunger, that sits over a springing mechanism, for example, a compression spring. This springing mechanism is a key feature, as it facilitates the easy removal of the standard outlet, significantly simplifying maintenance and replacement processes.

Inside the system, there are multiple metal female contacts, possibly bent brass contacts, that sit within an outlet housing insert. This outlet housing insert is specifically designed to receive the modified standard outlet, forming a connection between the male and female contacts. This innovative design ensures a secure and effective electrical connection, enhancing the system's reliability and functionality. Finally, the outlet housing insert fits inside a standard outlet box, making it a versatile solution that can be easily implemented in a wide range of settings without the need for extensive modifications to existing electrical infrastructures.

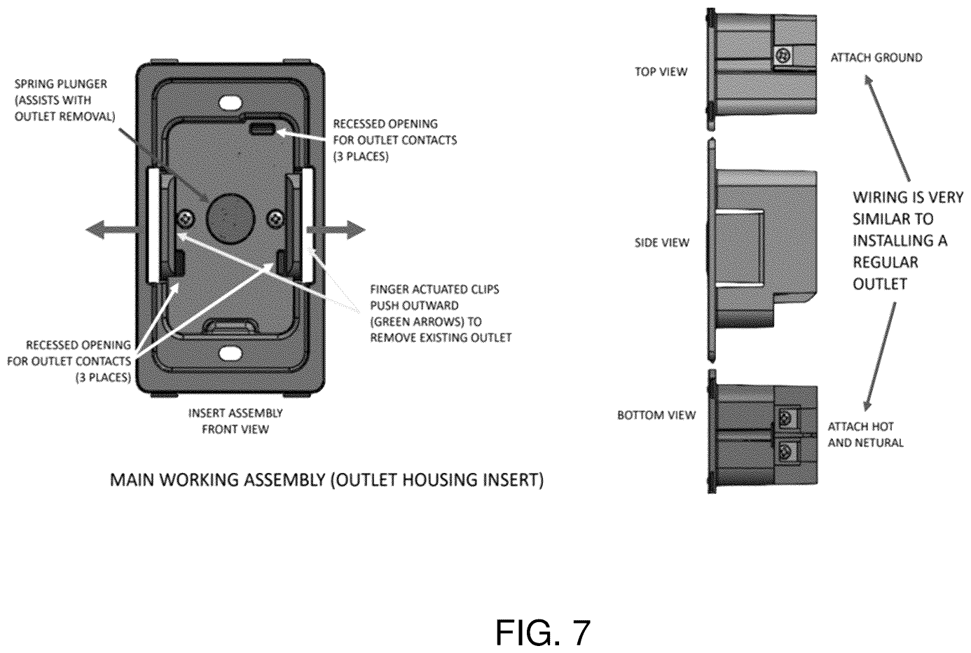

FIG. 7 depicts an illustrative schematic diagram for an enhanced power outlet, in accordance with one or more example embodiments of the present disclosure.

Referring to FIG. 7, an outlet housing insert is depicted, showcasing its detailed components and functionality. The insert primarily consists of a plastic cover that is attached to the outlet housing insert using various mechanisms, such as screws, to secure the plastic cover to the outlet housing insert. This method of attachment not only ensures a sturdy and reliable construction but also allows for easy disassembly if needed, enhancing the system's maintenance-friendly nature.

The plastic cover is designed with an opening that accommodates a spring plunger, which plays a crucial role in facilitating the outlet's removal. In operation, the outlet is pushed inside the outlet housing insert, making contact with the spring plunger. When the clips are pushed outward, the spring plunger is activated, effectively pushing out the outlet from the outlet housing insert. This innovative feature greatly simplifies the process of removing the outlet, making it a more user-friendly experience, especially for those not skilled in electrical work.

Various alternative mechanisms can be employed to achieve the same function as the clips for removing an electrical outlet from its housing. These include:

A lever mechanism can be integrated into the device's design. Users can activate the spring plunger by either pulling or pushing this lever, causing the outlet to be ejected from its housing. This method might be more intuitive and offer a controlled outlet ejection process.

A push button is another viable alternative. When pressed, it activates the spring plunger, simplifying the user interaction to a single press for releasing the outlet. This design is both user-friendly and ergonomic.

A rotational knob, where turning it in a specific direction engages the spring plunger, is another option. This mechanism is familiar to many users and allows for precise control over the ejection process.

A sliding switch could also be used. Moving the switch to a certain position would activate the spring plunger. This type of mechanism is common and easy to operate, requiring a simple slide action.

A magnetic release mechanism, where the alignment or misalignment of magnets activates the spring plunger, presents a novel approach. It could minimize the physical effort needed to eject the outlet.

Pneumatic or hydraulic triggers offer a more complex solution. These systems, when activated by the user, exert the necessary force on the spring plunger, potentially offering a smooth operation.

Lastly, a toggle switch could be implemented. Flipping this switch would activate the spring plunger mechanism, providing a clear indication of the ejection mechanism's on and off positions.

Each of these alternatives has its own set of advantages, ranging from ease of use and manufacturing simplicity to reliability. The choice of the most suitable mechanism would depend on the specific design requirements and constraints of the device.

Additionally, the plastic cover includes recessed openings for the outlet's electrical contacts. Although three recessed openings are depicted in FIG. 7, the design can accommodate any number of openings, varying based on the number of electrical contacts on the outlet. This flexibility in design ensures the system can be adapted to different types of outlets, enhancing its versatility and applicability in various electrical setups.

Moreover, the outlet housing insert can be connected to the existing wiring in the wall in a manner similar to installing a regular outlet. This includes provisions for connecting a ground wire, a hot wire, and a neutral wire to the outlet housing insert. These connection points are strategically designed to ensure a secure and safe electrical connection, mirroring the standard practices in outlet installation. The actual implementation and configuration of these connections may vary, providing adaptability to different wiring setups and requirements. This adaptability further underscores the system's innovative approach to combining ease of installation with robust and flexible design.

It is understood that the above descriptions are for the purposes of illustration and are not meant to be limiting.

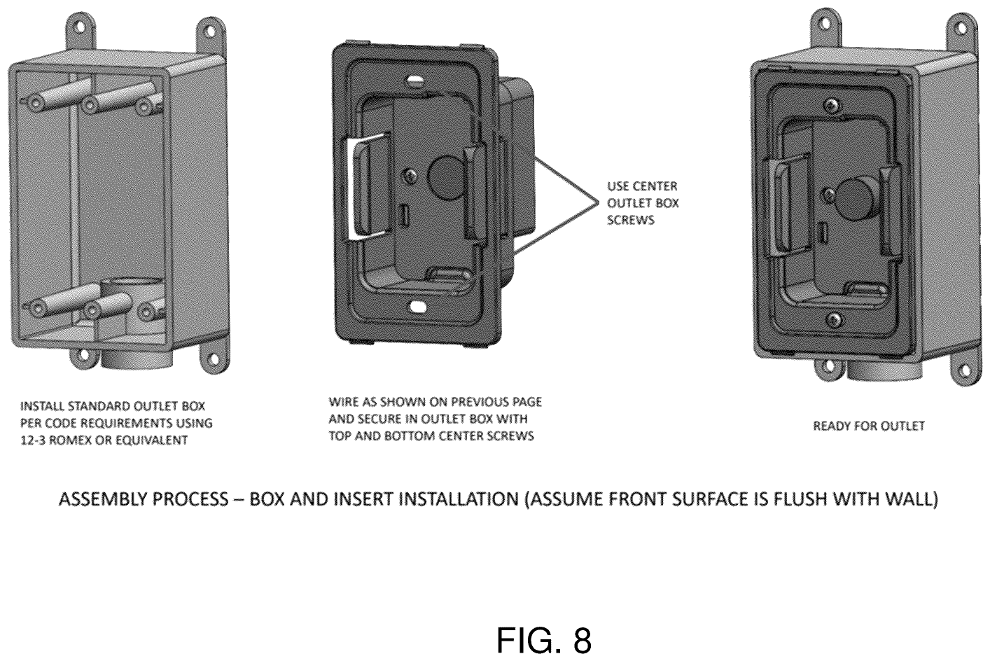

FIG. 8 depicts an illustrative schematic diagram for an enhanced power outlet, in accordance with one or more example embodiments of the present disclosure.

Referring to FIG. 8, there is shown an installation process of the enhanced power outlet system.

In the enhanced power outlet system, as illustrated in FIG. 8, the installation process involves an approach to wiring an outlet housing insert inside a standard outlet box. The wiring is secured to the outlet housing insert using a plurality of contact points (not shown here), a design that ensures a robust and reliable electrical connection. After the wiring is attached to the outlet housing insert, the insert itself is secured to the outlet box using top and bottom center screws.

The enhanced power outlet system's use of multiple contact points for wiring and the specific method of attaching the outlet housing insert to the outlet box underscores its safety and ease in electrical installations. After this initial installation, the outlet housing insert would then be capable of receiving an outlet that will fit in it and make an electrical connection using a plurality of male contacts and a plurality of female contacts.

It is understood that the above descriptions are for the purposes of illustration and are not meant to be limiting.

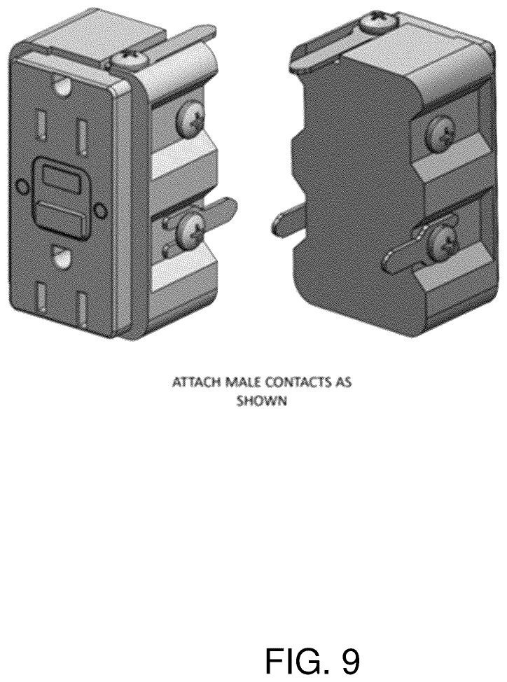

FIG. 9 depicts an illustrative schematic diagram for an enhanced power outlet, in accordance with one or more example embodiments of the present disclosure.

Referring to FIG. 9, there is shown the specific process for preparing a GFCI outlet in the enhanced power outlet system.

The assembly process in the enhanced power outlet system, as exemplified in FIG. 9 using a GFCI outlet, demonstrates the versatility of the system in accommodating various types of outlets. In the preparation of the GFCI outlet, a specific procedure is followed.

A first step is to attach male contacts to the existing contact points on the outlet. Attaching these male contacts is a key feature of the enhanced power outlet system, focusing on creating a robust and safe electrical connection. This step ensures that the GFCI outlet is adequately prepared to integrate effectively into the enhanced power outlet system.

Although FIG. 9 shows the process using a GFCI outlet, the enhanced power outlet system is designed to be compatible with a range of outlet types, underscoring its versatility. This approach ensures that the system can be adapted to various electrical setups, making it a practical and efficient solution for different installation needs.

It is understood that the above descriptions are for the purposes of illustration and are not meant to be limiting.

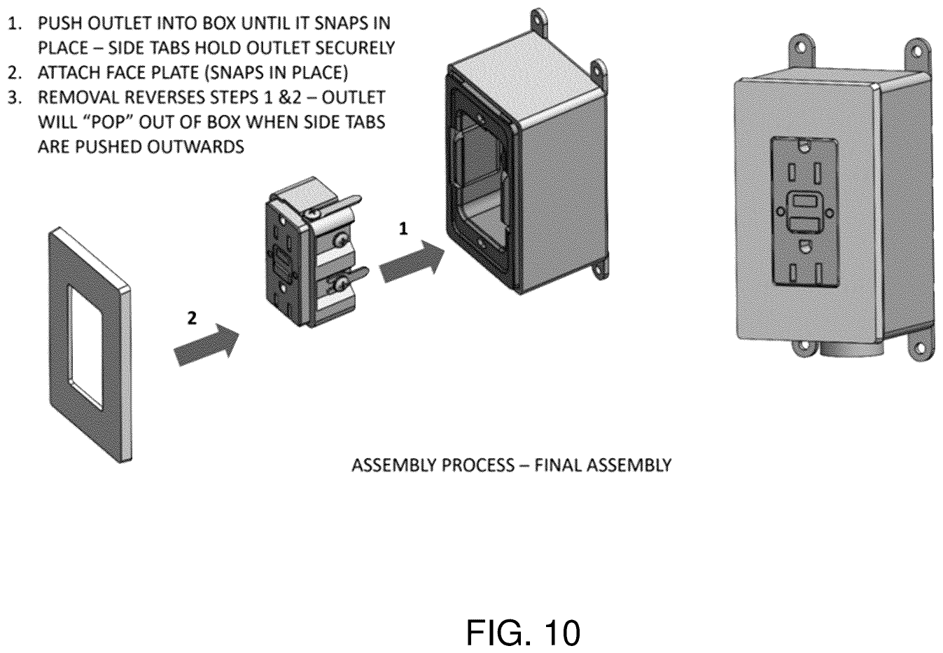

FIG. 10 depicts an illustrative schematic diagram for an enhanced power outlet, in accordance with one or more example embodiments of the present disclosure.

Referring to FIG. 10, there is shown an assembly process of the enhanced power outlet system.

The enhanced power outlet system's assembly process is designed for simplicity and efficiency in setting up an electrical outlet. This process is comprised of a few straightforward steps.

The outlet is initially positioned into the box until it is securely held by side tabs. This design element of the enhanced power outlet system ensures that the outlet is firmly and safely anchored in place, highlighting the system's focus on ease of installation and structural integrity. Next, the faceplate is attached, which seamlessly snaps into place. This snap-in mechanism for the faceplate in the enhanced power outlet system underscores the simplicity and speed of the assembly process, reflecting the system's commitment to user-friendly design. For removal, the process is simply the inverse of the installation. The outlet ‘pops’ out of the box when the side tabs are pushed outwards. This ‘pop-out’ feature of the enhanced power outlet system makes the removal process straightforward and safe, facilitating easy adjustments or replacements when needed.

Overall, the assembly process for the enhanced power outlet system's electrical outlet is tailored for ease of use, safety, and time efficiency, making it an advantageous solution for users seeking a hassle-free installation and maintenance experience.

It is understood that the above descriptions are for the purposes of illustration and are not meant to be limiting.

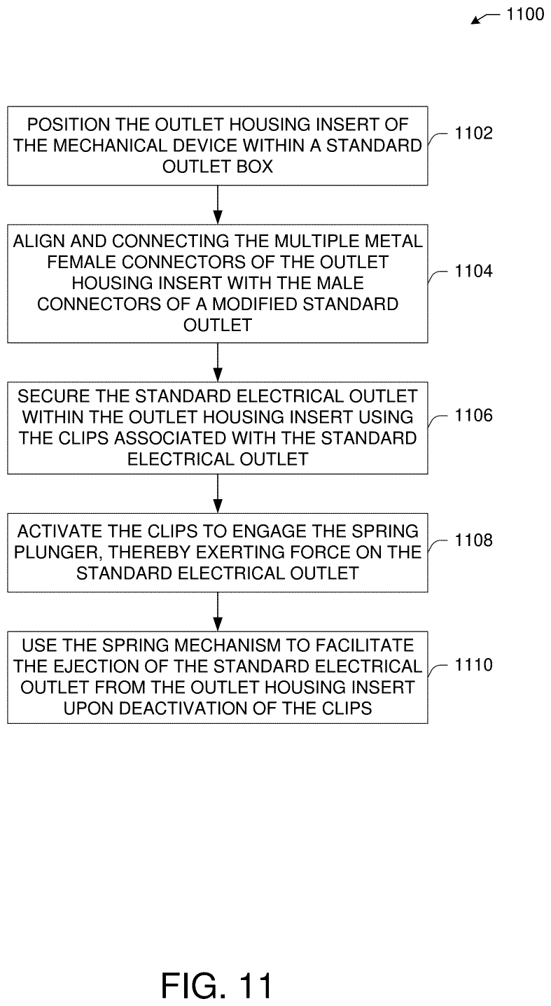

FIG. 11 illustrates a flow diagram of illustrative process 1100 for an illustrative enhanced power outlet system, in accordance with one or more example embodiments of the present disclosure.

In some embodiments, the electronic device(s), network(s), system(s), chip(s) or component(s), or portions or implementations thereof may be configured to perform one or more processes, techniques, or methods as described herein, or portions thereof. One such process is depicted in FIG. 11.

For example, the process may include, at 1102, positioning the outlet housing insert of the mechanical device within a standard outlet box.

The process further includes, at 1104, aligning and connecting the multiple metal female connectors of the outlet housing insert with the male connectors of a modified standard outlet.

The process further includes, at 1106, securing the standard electrical outlet within the outlet housing insert using the clips associated with the standard electrical outlet.

The process further includes, at 1108, activating the clips to engage the spring plunger, thereby exerting force on the standard electrical outlet.

The process further includes, at 1110, using the spring mechanism to facilitate the ejection of the standard electrical outlet from the outlet housing insert upon deactivation of the clips.

It is understood that the above descriptions are for the purposes of illustration and are not meant to be limiting.

The word “exemplary” is used herein to mean “serving as an example, instance, or illustration.” Any embodiment described herein as “exemplary” is not necessarily to be construed as preferred or advantageous over other embodiments.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented or may not necessarily need to be performed at all, according to some implementations. Certain aspects of the disclosure may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.”

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for an electrical outlet, comprising:
providing an outlet housing insert designed to fit within a standard outlet box;
integrating a spring mechanism, including a plastic spring cover over a springing mechanism;
configuring the spring mechanism to enable removal of a standard electrical outlet from the outlet housing insert; and
including multiple metal female contacts within the outlet housing insert, designed to receive a modified standard outlet and form a connection with the outlet's male contacts.

2. The system of claim 1, further comprising locking sliders that slide behind the snap tabs that hold the standard electrical outlet in place.

3. The system of claim 1, further comprising a plastic cover positioned between the standard electrical outlet and the spring mechanism.

4. The system of claim 3, wherein the plastic cover is configured to facilitate an alignment of the standard electrical outlet with the spring mechanism.

5. The system of claim 1, wherein the outlet housing insert is configured to securely hold the standard electrical outlet in place within the standard outlet box.

6. The system of claim 1, wherein the outlet housing insert includes attachment points for securing the insert to the standard outlet box using screws.

7. The system of claim 1, further comprising a mechanism for attaching and detaching the standard electrical outlet from the outlet housing insert.

8. The system of claim 1, wherein the outlet housing insert is compatible with a variety of standard electrical outlet types.

9. A mechanical device for facilitating an insertion and removal of a standard electrical outlet, comprising:
an outlet housing insert configured to fit within a standard outlet box;
a spring mechanism integrated within the device, including a springing element and a plastic cover over the springing element;
a spring plunger accommodated within an opening in the plastic cover, the spring plunger being operable to exert force on the standard electrical outlet;
clips associated with the standard electrical outlet, wherein activation of the clips results in an engagement of the spring plunger to eject the outlet from the outlet housing insert; and
multiple metal female connectors within the outlet housing insert, arranged to engage with male connectors of a modified standard outlet, establishing a mechanical and electrical connection.

10. The mechanical device of claim 9, further comprising locking sliders that slide behind the snap tabs that hold the standard electrical outlet in place.

11. The mechanical device of claim 9, wherein the plastic cover is positioned between the standard electrical outlet and the spring mechanism and is configured to facilitate alignment of the standard electrical outlet with the spring mechanism.

12. The mechanical device of claim 9, wherein the outlet housing insert is structured to maintain the standard electrical outlet securely within the standard outlet box.

13. The mechanical device of claim 9, wherein the outlet housing insert incorporates attachment features for securing the insert to the standard outlet box with fasteners such as screws.

14. The mechanical device of claim 9, further comprising a mechanism to enable attachment and detachment of the standard electrical outlet to and from the outlet housing insert.

15. The mechanical device of claim 9, wherein the outlet housing insert is adaptable for compatibility with various types of standard electrical outlets.

16. The mechanical device of claim 9, wherein the spring plunger is designed to be activated by an outward movement of the clips, effectively pushing out the outlet from the outlet housing insert.

17. A method of inserting and removing a standard electrical outlet from an outlet box, the method comprising:
positioning the outlet housing insert of the mechanical device within a standard outlet box;
aligning and connecting the multiple metal female connectors of the outlet housing insert with the male connectors of a modified standard outlet;
securing the standard electrical outlet within the outlet housing insert using the clips associated with the standard electrical outlet;
activating the clips to engage the spring plunger, thereby exerting force on the standard electrical outlet; and
using the spring mechanism to facilitate the ejection of the standard electrical outlet from the outlet housing insert upon deactivation of the clips.

18. The method of claim 17, wherein the metal female connectors composed of brass are used for establishing a mechanical and electrical connection between the modified standard outlet and the outlet housing insert.

19. The method of claim 17, wherein aligning the standard electrical outlet with the spring mechanism is facilitated by the plastic cover positioned between the standard electrical outlet and the spring mechanism.

20. The method of claim 17, further including the step of attaching the outlet housing insert to the standard outlet box using attachment features and fasteners such as screws.
